(19) United States
(12) Patent Application Publication
(10) Pub. No.: US 2015/0064475 A1
(43) Pub. Date: Mar. 5, 2015

(54) SAFETY AGGLUTINATION GLASS STRUCTURE

(71) Applicant: CHUNG HOW PAINT FACTORY CO., LTD., Tainan (TW)

(72) Inventor: WEN-TING WANG, TAINAN (TW)

(73) Assignee: CHUNG HOW PAINT FACTORY CO., LTD., Tainan (TW)

(21) Appl. No.: 14/014,598

(22) Filed: Aug. 30, 2013

(51) Int. Cl. B32B 7/12; B32B 17/10

(52) U.S. Cl. CPC B32B 7/12; B32B 17/10752; B32B 17/10614; B32B 17/1055; B32B 17/10036
USPC 428/412; 428/426; 428/432; 428/425.6; 428/442; 428/430

(57) ABSTRACT

The invention relates to a safety agglutination glass structure, comprising two glass substrates and a heat insulating adhesive membrane. The heat insulating adhesive membrane constituted of heat insulating particles and a colloid material is disposed between the two glass substrates. Therefore, the two glass substrates can combine together by heating and pressurizing for the purpose of simplifying processing procedures, reducing the costs and preventing distortion.

### BACKGROUND OF THE INVENTION

1. Field of the Invention

The present invention relates to a safety agglutination glass structure which can avoid the problems of bubbles formation and distortion during the bonding process and can effectively simplify the processing procedure.

2. Description of Related Art

As to the composition and process of the conventional agglutination glass, there are two forms as described below. First, as shown in FIG. 3, the conventional agglutination glass comprises two glass substrates (51), a heat insulating membrane (52), and two glue membranes (53), wherein the heat insulating membrane (52) is disposed between the two glass substrates (51) forming two spaces and the two glue membrane (53) are further disposed within the two spaces respectively. In manufacturing the conventional agglutination glass, the glue membrane (53) is disposed on a cleaned glass substrate (51), and the heat insulating membrane (52) is disposed on the glue membrane (53). Then the other glue membrane (53) is further placed on the heat insulating membrane (52) and finally is covered with the other glass substrate (51). The glue membrane (53) and the heat insulating membrane (52) can be combined by heating and pressurizing. However, this process will causes lots of bubbles under the glue membrane (53) when air gets trapped between membranes, and the heat insulating membrane (52) is also prone to shrinkage and distortion leading to the high defect probability of the finished goods. Therefore, many disadvantages still exist in the structure i.e. unstable product quality (bubble formation and distortion) and waste caused by complicacy in manufacturing procedure.

Also, as shown in FIG. 4, the conventional agglutination glass primarily comprises two glass substrates (61), a plating layer (62), and a glue membrane (63). Even though this structure and its laminating procedure can solve the aforementioned problem of distortion, one of the glass substrates (61) requires to be pre-plated with a metal plating layer (62). The other glass substrate (61) is further disposed with a glue membrane (63) and then combined with the glass substrate (61) covered with the plating layer (62) by heating and pressurizing. Accordingly, this conventional agglutination glass structure also has some disadvantages i.e. complicated process and waste of cost caused by necessary use of prior plating procedure and the complex manufacturing procedure.

### SUMMARY OF THE INVENTION

In view of the above-mentioned problems, the object of the present invention is to provide a safety agglutination glass structure which can avoid the problems of bubbles formation and distortion during the bonding process.

Disclosed herein is a safety agglutination glass structure, comprising two glass substrates and a heat insulating adhesive membrane, wherein the heat insulating adhesive membrane constituted of heat insulating particles and colloid material is disposed between the two glass substrates. Therefore, two glass substrates can combine together by heating and pressurizing for the purpose of simplifying laminating procedures, reducing the costs and preventing distortion.

The aforementioned safety agglutination glass structure is further provided with a powerful polycarbonate (PC) board between one of the glass substrates and the heat insulating adhesive membrane. Moreover, a glue membrane is disposed between the glass substrate and the PC board for combination. Therefore, the agglutination glass structure is equipped with the explosion-proof and bullet-proof safety efficacy.

In the safety agglutination glass structure as described above, the colloid material and the glue membrane are further made of polyvinyl butyral resin (PVB), ethylene vinyl acetate (EVA), thermoplastic polyurethane (TPU), terephthalic acid (TPA), or pressure sensitive adhesive (PSA).

In the safety agglutination glass structure as described above, the heat insulating particles can be nanometer indium tin oxide (ITO), complex nanometer tungsten oxide (WO₃), nanometer antimony tin oxide (ATO), nanometer lanthanum hexaboride (LaB₆), nanometer carbon black, or lithium fluoride tin oxide (LiFTO).

### BRIEF DESCRIPTION OF THE DRAWINGS

FIG. 1 is a sectional view of an embodiment according to the present invention.

FIG. 2 is a sectional view of another embodiment according to the present invention.

FIG. 3 is a schematic diagram of a conventional art.

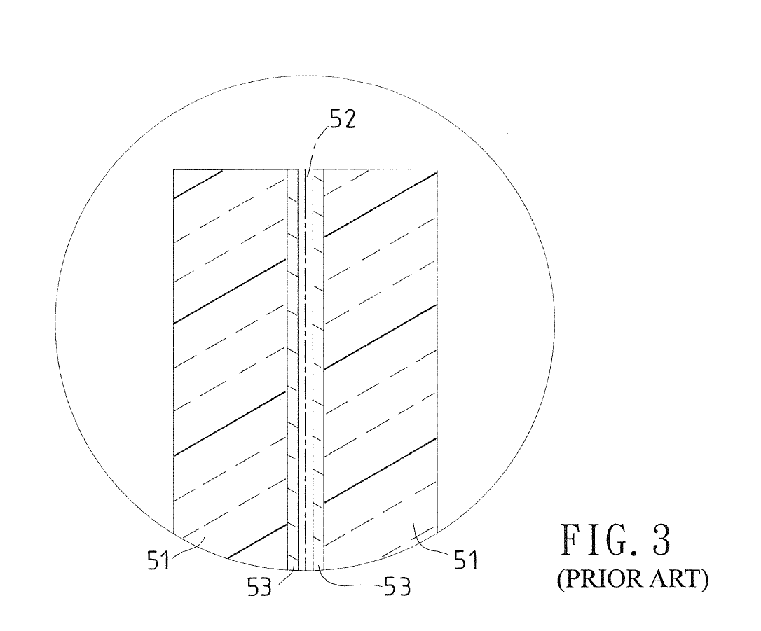

FIG. 4 is a schematic diagram of another conventional art.

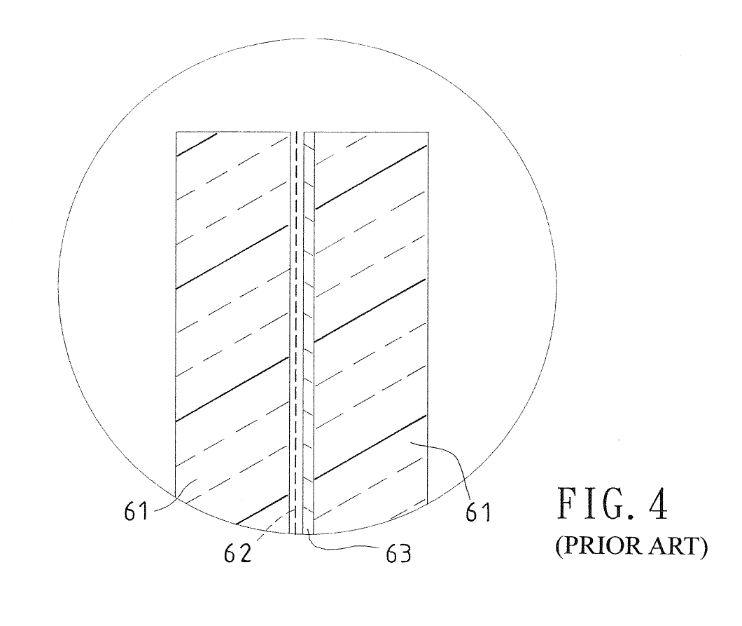

### DETAILED DESCRIPTION OF THE PREFERRED EMBODIMENT

Hereinafter, an exemplary embodiment of the present invention will be described in detail with reference to the accompanying drawings.

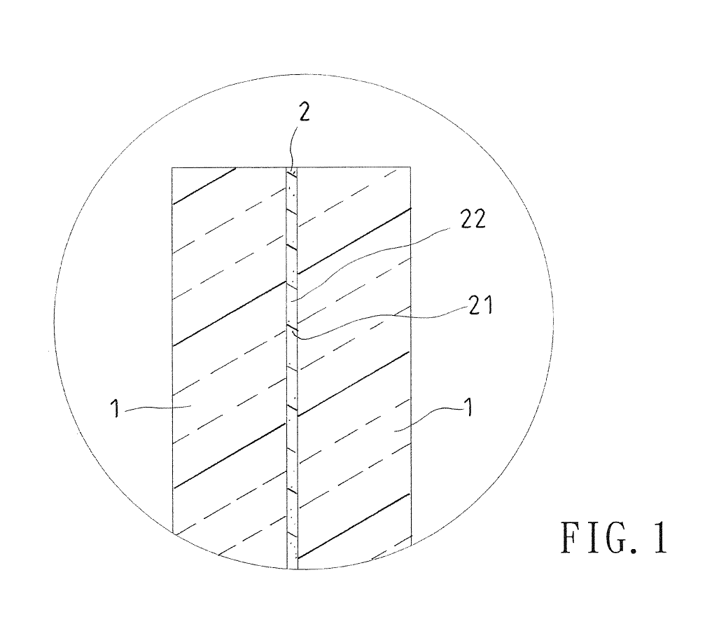

First, referring to FIG. 1, a sectional view of an embodiment of the present invention is disclosed. The safety agglutination glass structure mainly comprises:

two glass substrates (1); and

a heat insulating adhesive membrane (2) constituted of a mixture of heat insulating particles (21) and a colloid material (22), and disposed between the two glass substrates (1) for combining the two glass substrates.

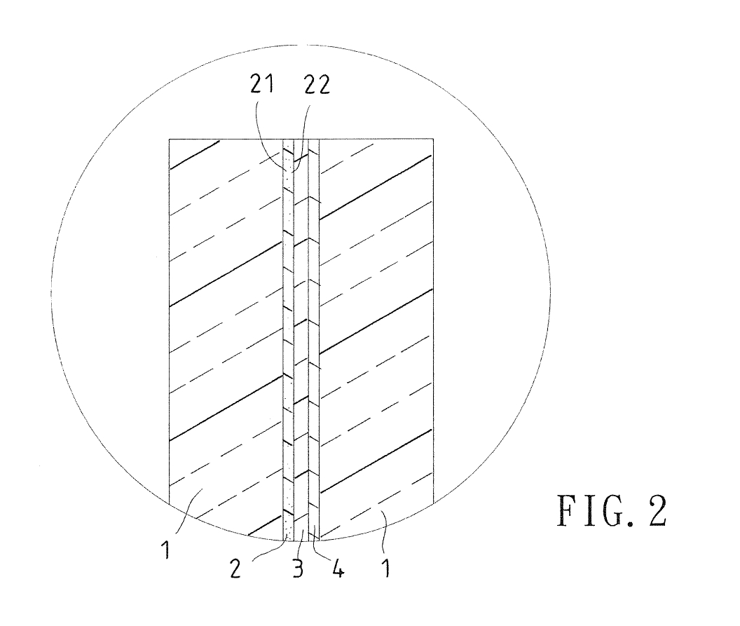

As shown in FIG. 1 and FIG. 2, in the laminating procedure, the glass substrate (1) can be a general glass or a tempered glass. The heat insulating particles (21) of the heat insulating adhesive membrane (2) can comprise a material selected from the group consisting of nanometer indium tin oxide (ITO), complex nanometer tungsten oxide (WO₃), nanometer antimony tin oxide (ATO), nanometer lanthanum hexaboride (LaB₆), nanometer carbon black and lithium fluoride tin oxide (LiFTO). The colloid material (22) comprises a compound selected from the group consisting of PVB, EVA, TPU, TPA, and PSA.

The heat insulating particles (21) and the colloid material (22) are mixed to constitute the heat insulating adhesive membrane (2) which is further disposed between the two glass substrates (1) for combining the two glass substrates (1) by heating and pressurizing and thus forming the agglutination glass.

Referring to FIG. 2, a powerful polycarbonate (PC) board (3) is disposed between one of the glass substrates (1) and the heat insulating adhesive membrane (2). Moreover, a glue membrane (4) also comprising a compound selected from the group consisting of PVB, EVA, TPU, TPA, and PSA, is further disposed between the glass substrate (1) and the PC board (3). Accordingly, the explosion-proof and bullet-proof safety agglutination glass is formed by heating and pressurizing.

According to the above description, in comparison with the traditional technique, a safety agglutination glass structure according to the present invention has the advantages as followings:
1. The present invention can simplify the laminating procedure as well as reduce the costs by means of disposing a heat insulating adhesive membrane within it in the processing procedure.
2. The present invention can also avoid the problems of bubbles formation and distortion by means of disposing a heat insulating adhesive membrane within it.
3. The present invention is provided with a powerful PC board disposed between the glass substrate and the heat insulating adhesive membrane. Therefore, the glass substrate and the heat insulating adhesive membrane can combine together for the purpose of forming an explosion-proof and bullet-proof safety agglutination glass.

What is claimed is:

1. A safety agglutination glass structure comprises:
two glass substrates; and
a heat insulating adhesive membrane constituted of a mixture of heat insulating particles and a colloid material, and disposed between the two glass substrates for combining the two glass substrates.

2. The safety agglutination glass structure as claimed in claim 1, wherein a powerful polycarbonate (PC) board is disposed between one of the glass substrates and the heat insulating adhesive membrane, and a glue membrane is disposed between the glass substrate and the polycarbonate (PC) board for combination thereof.

3. The safety agglutination glass structure as claimed in claim 1, wherein the heat insulating particle comprises a material selected from the group consisting of nanometer indium tin oxide (ITO), complex nanometer tungsten oxide (WO₃), nanometer antimony tin oxide (ATO), nanometer lanthanum hexaboride (LaB₆), nanometer carbon black and lithium fluoride tin oxide (LiFTO).

4. The safety agglutination glass structure as claimed in claim 1, wherein the colloid material comprises a compound selected from the group consisting of PVB, EVA, TPU, TPA, and PSA.

5. The safety agglutination glass structure as claimed in claim 2, wherein the heat insulating particle comprises a material selected from the group consisting of nanometer indium tin oxide (ITO), complex nanometer tungsten oxide (WO₃), nanometer antimony tin oxide (ATO), nanometer lanthanum hexaboride (LaB₆), nanometer carbon black and lithium fluoride tin oxide (LiFTO).

6. The safety agglutination glass structure as claimed in claim 2, wherein the colloid material comprises a compound selected from the group consisting of PVB, EVA, TPU, TPA, and PSA.
